(19) United States
(12) Patent Application Publication
(10) Pub. No.: US 2026/0236100 A1
(43) Pub. Date: Aug. 13, 2026

(54) SYSTEMS AND METHODS FOR NEURAL HAPTIC SIGNALS

(71) Applicant: Juan Manuel CRUZ HERNANDEZ, Westmount (CA)

(72) Inventor: Juan Manuel CRUZ HERNANDEZ, Westmount (CA)

(21) Appl. No.: 19/157,236

(22) PCT Filed: Feb. 16, 2024
(86) PCT No.: PCT/IB2024/051507

§ 371 Date: Aug. 15, 2025

Related U.S. Application Data
(60) Provisional application No. 63/485,433, filed on Feb. 16, 2023.

(51) Int. Cl. G06F 3/01

(52) U.S. Cl. CPC G06F 3/016; G06F 3/015

(57) ABSTRACT

A system for providing a neural haptic interface is provided. The system may include a memory unit configured to store computer instructions and at least one processor configured to execute the instructions. The instructions may cause the device to receive a notification from a peripheral device, determine a neural haptic effect to be performed according to the notification, generate a neural haptic signal corresponding to the neural haptic effect, and provide the neural haptic signal to a neural haptic device to render the neural haptic effect by stimulating a peripheral nervous system of a user.

### FIELD OF THE INVENTION

The present disclosure is related to neural haptic signals and devices, systems, and methods for generating and providing neural haptic signals.

### BACKGROUND OF THE INVENTION

Haptic feedback is the mediated touch between humans, humans and robots, or even robots and robots. The touch is mediated using a computer device, which is what allows haptic feedback to be programmable, as opposed to touch feedback provided by everyday objects. A haptic device is therefore a device that provides haptic feedback. The haptic feedback can be divided into two types of feedback: cutaneous feedback targeting the skin to provide vibrations, temperature, pain, etc., and kinesthetic feedback targeting movement of limbs in the body (e.g., fingers, arms, legs, or the entire body).

Haptic devices are commonplace through most of the world today. This can be seen in mobile devices that provide tactile feedback in the form of vibrations, when a user touches the touch screen of a smart cellphone device, and such device commands an internal vibration actuator (e.g., Linear Resonant Actuator or LRA) to produce the vibration that stimulates the sense of touch in the user's finger.

Gaming devices also exist that provide haptic feedback. For example, a game controller device used in gamming consoles provides rumble sensations using an Eccentric Rotating Mass (ERM) actuator or a Voice Coil Motor (VCM) actuator.

The latest generation of game controllers now includes haptic triggers with semi-kinesthetic feedback, this is, trigger can push or pull on the finger with small forces. Other devices that provide haptic feedback are haptic gloves which are gloves fitted with vibration or actuators that move the hand or fingers.

All haptic devices commonly used in the marketplace rely in electromechanical components to produce both tactile and kinesthetic sensations.

Haptic devices have been used in areas like Virtual Reality (VR), Augmented Reality (AR), Mixed Reality (MR) all know as extended Reality (XR), as well as in the Metaverse where interactions with virtual objects and all sorts of digital information require haptic feedback to create a true immersive experience.

All these immersive environments require the use of headset or glasses that present a complete virtual world or superimpose virtual objects and information in the real world when a user is wearing them.

Currently the interaction in these immersive environments is done using a hand controller fitted with a vibrating motor to provide vibrotactile feedback to the user. The controller is used to track the hands movements and location; however, the interactions are not natural as the user is kept from exploring the immersive environment with her own hands because the hands are holding the controller, and the user needs to learn how to use the controller which is detrimental to some applications where the user needs to focus on learning something else adding on the user cognitive load.

Other systems use gloves that allow for hand free interactions in these immersive environments as the gloves contain sensors that track the hand movements and location and have actuators that provide cutaneous or kinesthetic feedback. However, these gloves cannot be used for a long time as users sweat, the glove becomes uncomfortable. Another issue with the gloves is that one size does not fit all, they are not easy to wear, require time to fit them in the hands, and sometimes require the help of others to wear them.

Other immersive systems do not use anything and track directly the hands using cameras located in a room or in the headset or use a wearable bracelet to “guess” the movement and location of the fingers and the hand. The issue with avoiding the use of controllers or gloves is that the system no longer can provide haptic feedback at the fingertips or the hand.

### SUMMARY OF THE INVENTION

In an embodiment, a system for providing a neural haptic interface is provided. The system may include a memory unit configured to store computer instructions and at least one processor configured to execute the instructions to: receive a notification from a peripheral device; determine a neural haptic effect to be performed according to the notification; generate a neural haptic signal corresponding to the neural haptic effect; provide the neural haptic signal to a neural haptic device to render the neural haptic effect by stimulating a peripheral nervous system of a user.

### BRIEF DESCRIPTION OF THE FIGURES

FIG. 1 illustrates a neural haptic system consistent with embodiments hereof.

FIG. 2 illustrates the neural haptic system as incorporated into a variety of different user wearable devices

FIG. 3 illustrates the ulnar nerve and the median nerve of the arm.

FIG. 4 illustrates an example of the neural haptic system embodied as a bracelet or watch) with an electrode pattern consistent with embodiments hereof.

FIG. 5 illustrates an example of the neural haptic system embodied as a bracelet or watch) with an electrode pattern consistent with embodiments hereof.

FIG. 6 illustrates an example of the neural haptic system embodied as a bracelet or watch) with an electrode pattern consistent with embodiments hereof.

FIG. 7 illustrates an example of the neural haptic system embodied as a bracelet or watch) with an electrode pattern consistent with embodiments hereof.

FIG. 8 illustrates an example of the neural haptic system embodied as a bracelet or watch) with an electrode pattern consistent with embodiments hereof.

FIG. 9 illustrates use of a neural haptic system according to embodiments hereof.

FIG. 10 illustrates use of a neural haptic system according to embodiments hereof.

FIG. 11 illustrates use of a neural haptic system according to embodiments hereof.

FIG. 12 is a flow chart illustrating steps in a method of providing neural haptic notification of alert effects.

FIG. 13 illustrates the neural haptic system 100 used to detect neural signals and provide neural haptic signals as an output.

FIG. 14 illustrates flow charts illustrating steps in various methods for generating and providing neural haptic effects associated with an interactive user system.

### DETAILED DESCRIPTION OF THE INVENTION

The present disclosure provides systems, devices, and methods for providing haptic feedback or haptic sensations via neural interface.

The nervous system is a complex system consisting of a network of nerve cells and fibers that coordinates the actions and sensory information of a body and transmits signals to and from different parts of the body. A neural interface is a device that interacts with the nervous system, either via receiving or recording information from the nervous system (e.g., by sensing nerve impulses) and/or via stimulating the nervous system (e.g., by providing or otherwise inducing nerve impulses). As referred to herein, the “nervous system” may include either the central nervous system (CNS) or the peripheral nervous system (PNS) and all components thereof, including at least motor (efferrent) neurons, sensory (afferent) neurons, spinal nerves, and the brain. Neural interfaces consistent with the present disclosure may be implanted inside the body (invasively to the body) or located on the surface the body (external or non-invasive to the body).

There are different techniques and methods that may be used to interact with the nervous system using different principles. There are techniques that read from the nervous system, others that write or stimulate the nervous system, and others that can both read and write from to the nervous system.

Table 1 provides a list of technologies that may be used to read information of the nervous system. These techniques may sense electricity, sense magnetic fields, sense light, and/or sense sound.

TABLE 1

| | Read/ | Invasive/ Non- | Basic |
|---|---|---|---|
| | Write | invasive | Principle |
| Electromyography (EMG) | R/W | I/NI | Electricity |
| Electroencephalography (EEG) | R | NI | Electricity |
| Magnetencephalography (MEG) | R | NI | Magnetism |
| Functional Near-Infrared | R | NI | Light |
| Spectroscopy (fNIRS) | | | |
| Microwave Imaging | R | NI | Electricity (RF) |
| Electrocorticography (ECoG) | R | I | Electricity |
| Micro ECoG | R/W | I | Electricity |
| Stereotactic | R/W | I | Electricity |
| Electroencephalography (sEEG) | | | |
| Electronic Dura (eDura) | R/w | 1 | Electricity |
| Neural Lace (neuralink) | R/w | 1 | Electricity |
| Neural dust | R | 1 | Sound |
| Stentrode | R/W | I | Electricity |

Table 2 provides a list of technologies that may be used to send information to the nervous system, e.g., to stimulate a nerve. These techniques may use electricity, magnetic fields, light, and/or sound.

TABLE 2

| | Read/ | Invasive/Non- | |
|---|---|---|---|
| | Write | invasive | Principle |
| Deep Brain Stimulation (DBS) | R/W | I | Electricity |
| Intra-cortical micro-stimulation | W | I | Electricity |
| (ICMS) | | | |
| Optogenetics | W | I/NI | Light (genetics) |
| Nerve Stimulation | R/W | I | Electricity |
| Transcranial Electrical Stimulation | W | NI | Electricity |
| (TES) | | | |
| Transcranial Magnetic Stimulation | W | NI | Magnetism |
| (TMS) | | | |
| Transcranial Focus UltraSound | W | NI | Sound |
| (tFUS) | | | |
| Functional Electrical Stimulation | W | NI | Electricity |
| (FES) | | | |
| Transcutaneous Nerve Stimulation | W | NI | Electricity |
| (TNS) | | | |

The neural interface technologies listed above may interact with different function in the human body, including vision, hearing, speech, and touch. Embodiments described herein may include any of the above neural interface technologies or any other suitable neural interface technology.

Some specific embodiments discussed herein involve the use of neural interface technologies that interact with the human sense of touch. For example, it has been shown that sound or ultrasound may generate touch sensations when a beam of ultrasound signal is targeted at the somatosensory cortex of a human brain.

Other specific embodiments described herein may include an optogenetics technique, a biological technique that controls the activity of neurons with light, to target the somatosensory cortex to induce touch sensations. In further embodiments of the present disclosure, a technique used to stimulate the nervous system includes the use of electricity, either directed to the neurons in the brain or to neurons in the peripheral nervous system. Accordingly, systems, devices, and methods described herein may use light, sound, electricity, magnetism, and/or any combination of these techniques generate touch sensations by applying different excitation modes at different parts of the body.

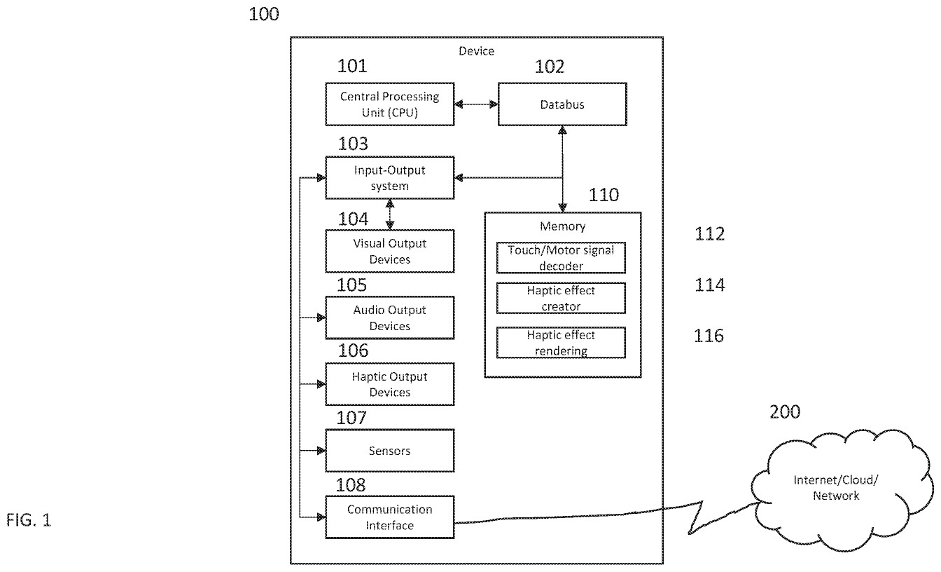

FIG. 1 illustrates a neural haptic system. The neural haptic system 100 may include any combination of at least one processing unit (also referred to as a CPU) 101, an input-output system 103, a visual output device(s) 104, an audio output device(s) 105, a haptic output device(s) 106, sensors 107, a communication interface 108, a databus 102, and a memory device 110. The memory device may be configured to store instructions for the processing unit 101 to implement various features of the neural haptic system 101, including at least a signal decoder 112, a haptic effect creator 114, and a haptic effect rendering module 116. The neural haptic system 100 may be configured to communicate with other devices either directly (e.g., via bluetooth or other direct communications technology) or via a network 200.

Although illustrated in FIG. 1 as a single device, the neural haptic system 100 may comprise multiple separate components. For example, the various output devices (visual, audio, haptic) may be non-collocated with the CPU 101, databus 102, memory 110, and input/output system 103. Similarly the sensors 107 may be non-collocated. In various embodiments, each of the components of the neural haptic system 100 may be collocated or non-collocated in any suitable combination.

The network 200 may be connected via wired or wireless links. Wired links may include Digital Subscriber Line (DSL), coaxial cable lines, or optical fiber lines. Wireless links may include Bluetooth®, Bluetooth Low Energy (BLE), ANT/ANT+, ZigBee, Z-Wave, Thread, Wi-Fi®, Worldwide Interoperability for Microwave Access (WiMAX®), mobile WiMAX®, WiMAX®-Advanced, NFC, SigFox, LoRa, Random Phase Multiple Access (RPMA), Weightless-N/P/W, an infrared channel or a satellite band. The wireless links may also include any cellular network standards to communicate among mobile devices, including standards that qualify as 2G, 3G, 4G, or 5G. Wireless standards may use various channel access methods, e.g., FDMA, TDMA, CDMA, or SDMA. In some embodiments, different types of data may be transmitted via different links and standards. In other embodiments, the same types of data may be transmitted via different links and standards. Network communications may be conducted via any suitable protocol, including, e.g., http, tcp/ip, udp, ethernet, ATM, etc.

The network 200 may be any type and/or form of network. The geographical scope of the network may vary widely and the network 200 can be a body area network (BAN), a personal area network (PAN), a local-area network (LAN), e.g., Intranet, a metropolitan area network (MAN), a wide area network (WAN), or the Internet. The topology of the network 200 may be of any form and may include, e.g., any of the following: point-to-point, bus, star, ring, mesh, or tree. The network 200 may be of any such network topology as known to those ordinarily skilled in the art capable of supporting the operations described herein. The network 200 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv4 and IPv4), or the link layer. The network 199 may be a type of broadcast network, a telecommunications network, a data communication network, or a computer network.

The memory 110 includes any type of non-transitory computer readable storage medium (or media) and/or non-transitory computer readable storage device. Such computer readable storage media or devices may store computer readable program instructions for causing a processor to carry out one or more methodologies described here. Examples of the computer readable storage medium or device may include, but is not limited to an electronic storage device, a magnetic storage device, an optical storage device, an electromagnetic storage device, a semiconductor storage device, or any suitable combination thereof, for example, such as a computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, but not limited to only those examples.

The at least one processor 101 (also interchangeably referred to herein as processors 101, processor(s) 101, or processor 101 for convenience), may include any suitable computer processing unit (CPU). In embodiments, the functionality of the processor may be performed by hardware (e.g., through the use of an application specific integrated circuit (“ASIC”), a programmable gate array (“PGA”), a field programmable gate array (“FPGA”), etc.), or any combination of hardware and software. The storage device 120 includes any type of non-transitory computer readable storage medium (or media) and/or non-transitory computer readable storage device. Such computer readable storage media or devices may store computer readable program instructions for causing a processor to carry out one or more methodologies described here. Examples of the computer readable storage medium or device may include, but is not limited to an electronic storage device, a magnetic storage device, an optical storage device, an electromagnetic storage device, a semiconductor storage device, or any suitable combination thereof, for example, such as a computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, but not limited to only those examples.

The processor 101 may be programmed by one or more computer program instructions stored on the storage device 110. For example, the processor 101 may be programmed by one or more of a signal decoder 112, a haptic effect creator 114, and a haptic effect rendering module 116, as well as other suitable program modules. It will be understood that the functionality of the various coding modules as discussed herein is representative and not limiting. Additionally, the storage device 110 may act as a data retention system to provide data storage. As used herein, for convenience, the various managers or software modules may be described as performing operations, when, in fact, the managers program the processor 101 (and therefore the neural haptics system 100) perform the operation.

The various components of the neural haptic system 100 work in concert to receive input from various modalities (as discussed further below) and provide neural haptic feedback (e.g., via stimulation of the nervous system) to a user.

The signal decoder 112 is a software protocol operating on the neural haptic system 100. The signal decoder 112 is configured to receive neurological signals from one or more user devices that are configured to monitor, sense, detect, or otherwise capture neurological signals in the body. The signal decoder 112 receives one or more neurological signals and decodes these according to several factors, such as device parameters (type, sensors used, etc.), device location, user factors (age, size, weight, etc.), environmental context factors (usage, movement, temperature, humidity, etc.), calibration factors, and others. Decoding the neurological signals permits the signal decoder 112 to generate signal information, including signal classification (e.g., as motor or sensory), signal intensity, and signal nature. Signal nature may include an indication of the type of sensory input that generated the signal, e.g., pleasure, pain, temperature, vibration, touch, auditory, olfactory, taste, pressure, surface texture, surface curvature, surface friction, surface shape, direction of tangentially applied forces, etc.

The haptic effect creator 114 is a software protocol operating on the neural haptic system 100. The haptic effect creator 114 is configured to create neural haptic effects for output to a user. The haptic effects may be created according to one or more of the signal information, contextual information, and/or intent information. Signal information is discussed above. Contextual information may include applications that may be running, environmental information, XR environment information used in a simulation, biological information pickup by device, hand tremor information, etc. Intent information may include information about the goal or intent of a signal, e.g., notification intent, information transfer intent, status transfer intent, signal modification intent (masking or modify human tremor in people with Parkinson disease, avoiding stepping into a hazardous area by a diabetic person), etc.

The haptic effect rendering module 116 is a software protocol operating on the neural haptic system 100. The haptic effect rendering module 116 is configured to generate haptic signals to be output to a neural haptic output device 106 to provide a user with a neural haptic stimulus. The haptic effect rendering module 116 may generate a neural haptic signal according to the neural haptic effects generated by the haptic effect creator and by haptic output parameters associated with the neural haptic output device 106. For example, haptic output parameters may include the shape of signal (e.g. square, sine, etc.), polarity (positive, negative or both), frequency of signal and frequency variation over time (rate encoding), duty cycle pulse width modulation and with modulation over time, signal magnitude, signal duration; use of multiple signals, (as in using two or more electrodes), considerations of phase among signals, delays among signals, weight factors among signals, etc.

The input-output system 103 is a system including both hardware and software configured to receive one or more inputs and provide these to the CPU 101 (e.g., via a databus 102) and/or to store such inputs in the memory 110. The input-output system 103 is further configured to provide outputs to various output devices associated with the neural haptic system 100.

The input-output system 103 may receive information from sensors 107. Sensors 107 may include, for example, neural sensors, microphones, cameras, light sensors, motion sensors, pressure sensors, EEG sensors, heart rate sensors, radiation sensors, proximity sensors, humidity sensors, chemical sensors, force sensors, hall effect sensors, oxygen sensors, gyroscope, accelerometer, capacitive sensor, inclinometer, LIDAR, colorimeter, infra-red sensor, etc. Neural sensors 107 associated with the neural haptic system may employ any suitable neural detection technique, including but not limited to those shown in Table 1.

The input-output system 103 may receive information from a communication interface 108. The communication interface 108 may include hardware and software components necessary for external communication with any external devices, including any devices connected via the various forms of network 200 described above as well as any devices associated with the neural haptic system 100. In embodiments, the communication interface 108 may be configured to communicate with a user device, such as a tablet, smartphone, smartwatch, etc., of a user, thereby enabling a user's devices to engage the neural haptic system 100 to provide haptic feedback to the user. In further embodiments, the neural haptic system 100 may be incorporated within such a device of a user and, in addition to the capabilities described herein, may also provide the full suite of capabilities associated with such a device.

The visual output device 104 may be configured to provide visual outputs to a user. The visual output device 104 may include any suitable device for outputting visual information, including but not limited to an LED display, LCD display, CRT display, lights, E-ink, plasma screens, electroluminescent display, OLED display, AMOLED display, Quantum dot display.

The audio output device 105 may be configured to provide audio outputs to a user. The audio output device 105 may include any suitable device for outputting audio information, including, but not limited to, speakers, bone-conduction speakers, direct neural signal (for example, by auditory nerve stimulation).

The haptic output device 106 may be configured to provide neural haptic outputs to a user, as described further herein. Haptic output devices 106 consistent with embodiments hereof are described in greater detail below. Haptic output devices 106 associated with the neural haptic system may employ any suitable neural stimulus technique, including but not limited to those shown in Table 2.

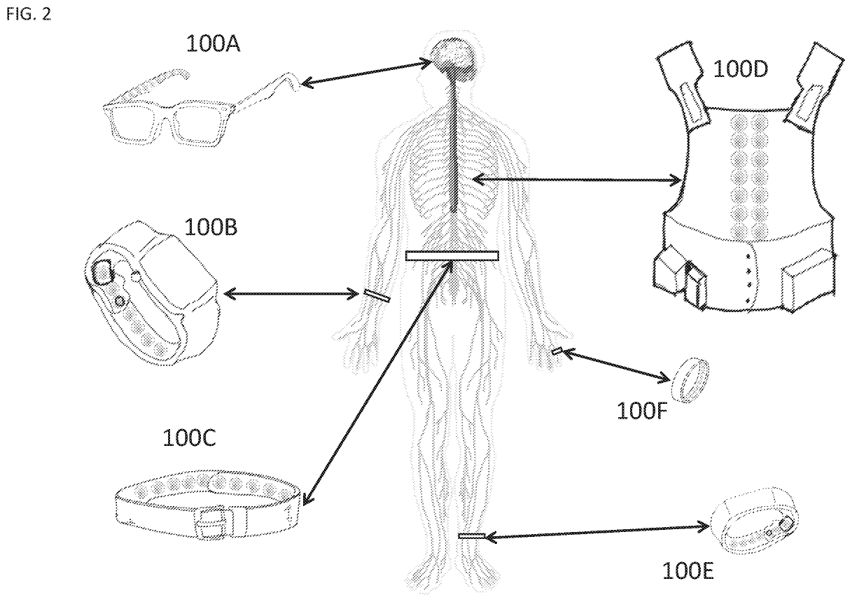

FIG. 2 illustrates the neural haptic system 100 as incorporated into a variety of different user wearable devices, including, for example, a ring (100F), bracelet or watch (100B), ankle bracelet (100E), belt (100C), necklace (100G, not shown), device around the ear (100H, not shown), glasses (100A), vest with electrodes around the spinal cord (100D), band around the leg (1001, not shown), or pants with multiple electrodes (100J, not shown). Each of these devices may house all or a portion of the neural haptic system 100. In embodiments, any or all of these devices may be combined to enhance the input output capabilities of the neural haptic system 100. In embodiments, any or all of these devices, in any combination, may act as peripherals to provide input/output capabilities to the neural haptic system 100, where some components of the neural haptic system are housed in a central unit.

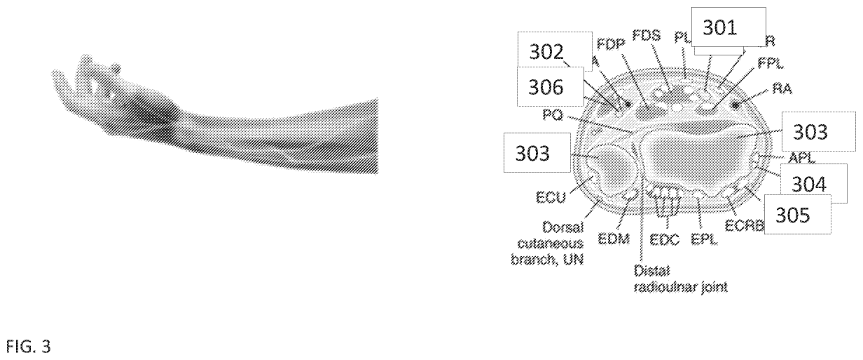

FIGS. 3-9 provide examples of haptic neural interfaces with the peripheral nerves of a user's arm. FIG. 3 illustrates the ulnar nerve and the median nerve of the arm. The ulnar nerve 302 and the median nerve 301 provide motor innervation to various muscles 306 of the arm and hand and provide sensory innervation to various portions of the arm and hand as well. FIG. 3 further illustrates ligaments 305, tendons 304, and bones 303. Although a specific depiction, relative to the nerves of the arm, is illustrated in FIGS. 3-9, these illustrations are provided by way of example only and the invention described herein is not limited thereby. As discussed above, neural haptic systems 100 consistent with this disclosure may be configured to stimulate various nerves throughout the body using various techniques.

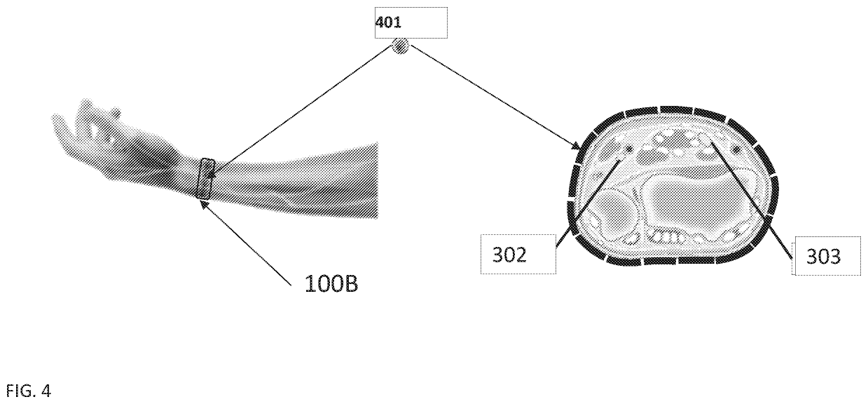

FIG. 4 illustrates an example of the neural haptic system 100 (or component thereof) embodied as a bracelet (or watch) 100B. The neural haptic system 100B may include one or more electrodes 401 located so as to surround the arm. The electrodes 401 are configured to stimulate one or more of the ulnar nerve 302 and the median nerve 301 when activated. The electrodes 401 are configured to transcutaneous neural stimulus. The electrodes 401 may be considered as being or belonging to the haptic output device 106 of the neural haptic system 100B.

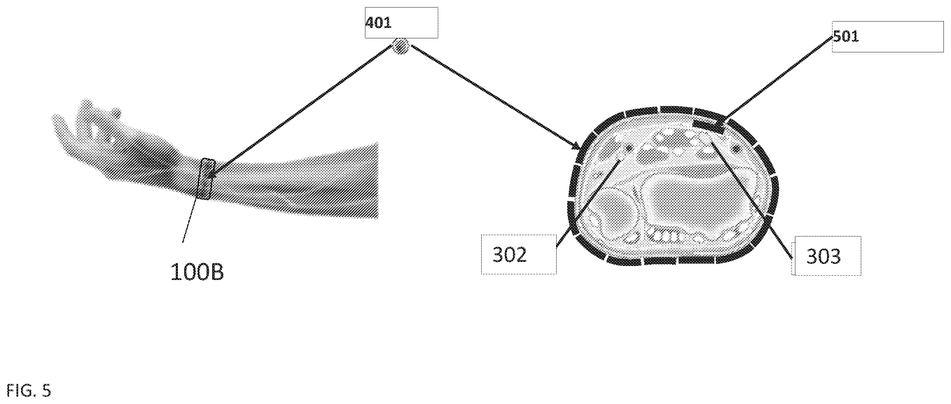

FIG. 5 illustrates an example of the neural haptic system 100 (or component thereof) embodied as a bracelet (or watch) 100B. The neural haptic system 100B may include one or more electrodes 401 located so as to surround the arm for transcutaneous stimulus as well as one or more subcutaneous electrodes 501. The subcutaneous electrodes 501 are configured for subcutaneous stimulation of one or more of the ulnar nerve 302 or median nerve 301. The subcutaneous electrodes 501 may not be physically connected to the neural haptic system 100B, but may receive signals wirelessly for neural stimulus. Although this embodiment is shown with both transcutaneous electrodes 401 and subcutaneous electrodes 501, it may be carried out with only subcutaneous electrodes 501.

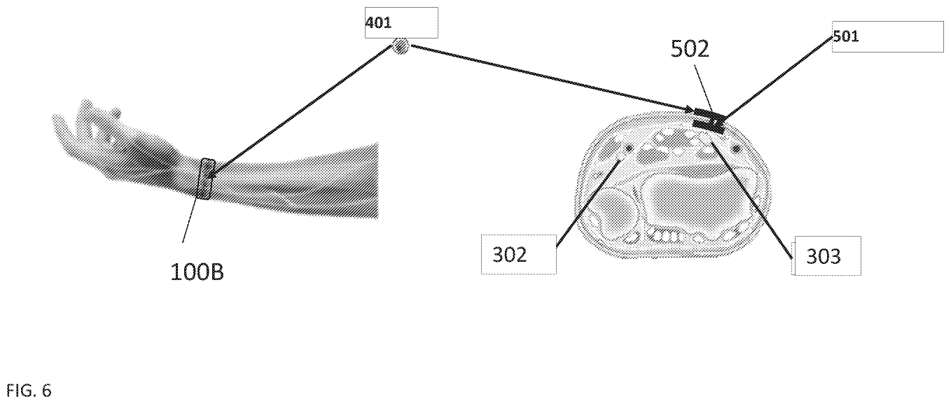

FIG. 6 illustrates an example of the neural haptic system 100 (or component thereof) embodied as a bracelet (or watch) 100B. The neural haptic system 100B may include one or more electrodes 401 located externally for transcutaneous stimulus as well as one or more subcutaneous electrodes 501. The subcutaneous electrodes 501 are configured for subcutaneous stimulation of one or more of the ulnar nerve 302 or median nerve 301. The subcutaneous electrodes 501 may be physically connected to the neural haptic system 100B, e.g., to the transcutaneous electrodes 401 via conduit 502. The subcutaneous electrodes 501 may receive signals for neural stimulus via the conduit 502. Although this embodiment is shown with both transcutaneous electrodes 401 and subcutaneous electrodes 501, it may be carried out with only subcutaneous electrodes 501.

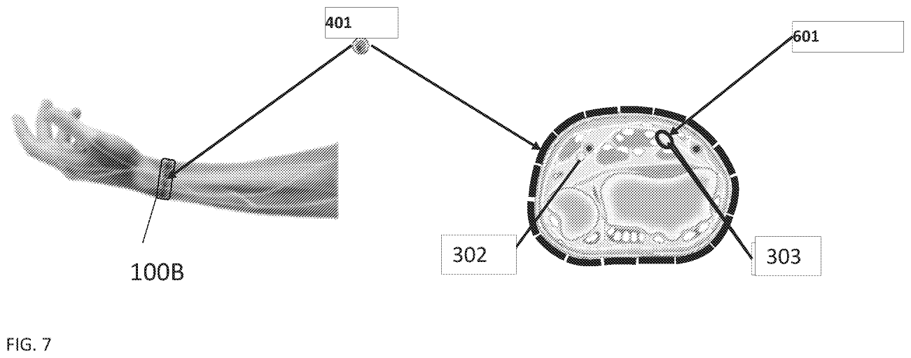

FIG. 7 illustrates an example of the neural haptic system 100 (or component thereof) embodied as a bracelet (or watch) 100B. The neural haptic system 100B may include one or more electrodes 401 located externally for transcutaneous stimulus as well as one or more nerve cuff electrodes 601. The nerve cuff electrodes 601 are configured for location on (e.g. partially or completely wrapping around) and stimulation of one or more of the ulnar nerve 302 or median nerve 301. The nerve cuff electrodes 601 may be include a single electrode or an array of electrodes. The subcutaneous electrodes 601 may be wirelessly connected to the neural haptic system 100B, e.g., to the transcutaneous electrodes 401 or to any other signal providing component of the neural haptic system 100B. The nerve cuff electrodes 601 may receive signals for neural stimulus wirelessly. Although this embodiment is shown with both transcutaneous electrodes 401 and nerve cuff electrodes 601, it may be carried out with only nerve cuff electrodes 601.

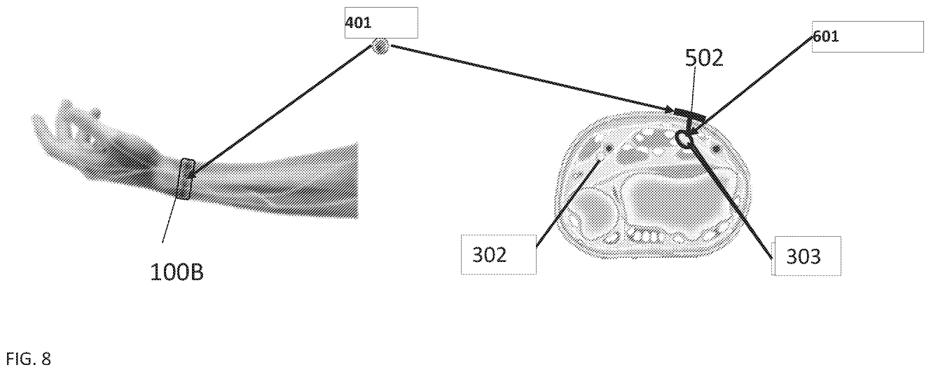

FIG. 8 illustrates an example of the neural haptic system 100 (or component thereof) embodied as a bracelet (or watch) 100B. The neural haptic system 100B may include one or more electrodes 401 located externally for transcutaneous stimulus as well as one or more nerve cuff electrodes 601. The nerve cuff electrodes 601 are configured for location on (e.g. partially or completely wrapping around) and stimulation of one or more of the ulnar nerve 302 or median nerve 301. The nerve cuff electrodes 601 may be include a single electrode or an array of electrodes. The subcutaneous electrodes 601 may be physically connected to the neural haptic system 100B, e.g., to the transcutaneous electrodes 401 or to any other signal providing component of the neural haptic system 100B via the conduit 502. The nerve cuff electrodes 601 may receive signals for neural stimulus in a wired fashion. Although this embodiment is shown with both transcutaneous electrodes 401 and nerve cuff electrodes 601, it may be carried out with only nerve cuff electrodes 601.

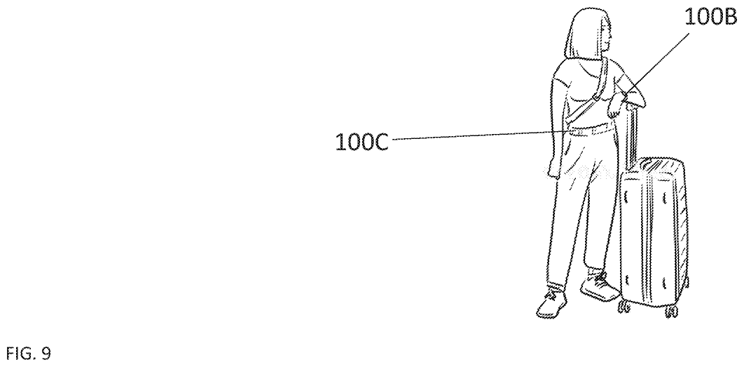

FIG. 9 illustrates use of a neural haptic system according to embodiments hereof. As shown in FIG. 9, a user employing a neural haptic system 100C (e.g., embodied as a belt) and a neural haptic system 100B (e.g., embodied as a bracelet), may receive notifications, alerts, indications, etc. via neural haptic signaling. For example, one or more of neural haptic system 100B and 100C may be in communication with a smartphone or other device of the user. When a notification (e.g., call, text, email, etc.) arrives at the user device, the user device communicates with the neural haptic system 100B/100C to provide the user with a neural haptic stimulus associated with the notification. Although the neural haptic systems 100B/100C are illustrated, any suitable form factor of the neural haptic system 100 may be used.

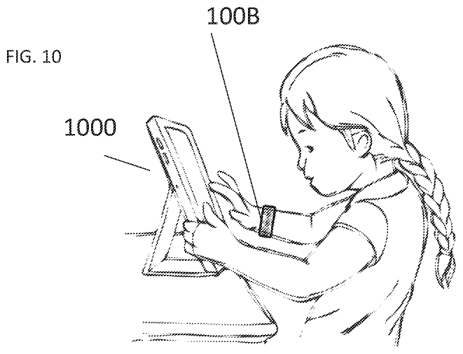

FIG. 10 illustrates use of a neural haptic system according to embodiments hereof. As shown in FIG. 10 a user employing a neural haptic system 100B (e.g., embodied as a bracelet), may receive neural haptic stimulus related to or associated with an application or activity being interacted with on a tablet, computer, video game console, or other user interactive system 1000. As shown in FIG. 10, the neural haptic system 100B may establish a connection with the user interactive system 1000 and provide neural haptic stimulus associated with interaction with the user interactive system 1000. Although the neural haptic systems 100B is illustrated, any suitable form factor of the neural haptic system 100 may be used.

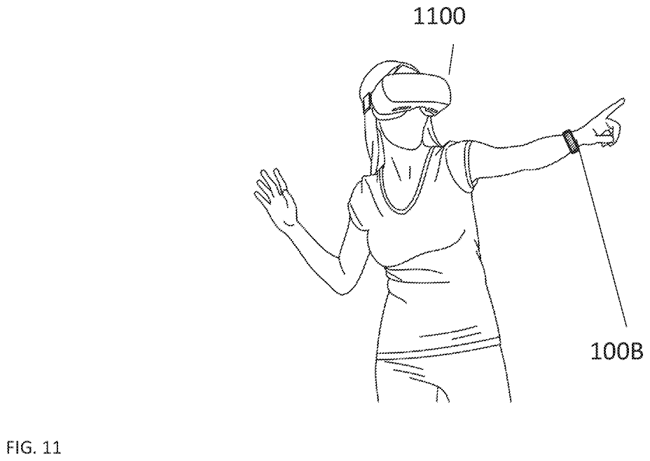

FIG. 11 illustrates use of a neural haptic system according to embodiments hereof. As shown in FIG. 11 a user employing a neural haptic system 100B (e.g., embodied as a bracelet), may receive neural haptic stimulus related to or associated with an application or activity being interacted with on a virtual reality system 1100 (or a mixed reality or augmented reality system). As shown in FIG. 11, the neural haptic system 100B may establish a connection with the user interactive system 1100 and provide neural haptic stimulus associated with interaction with the virtual reality system 1100. Although the neural haptic system 100B is illustrated, any suitable form factor of the neural haptic system 100 may be used.

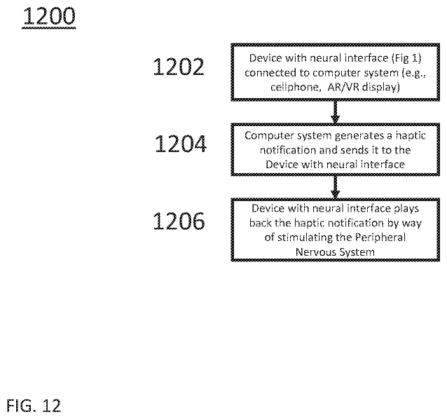

FIG. 12 is a flow chart illustrating steps in a method of providing neural haptic notification of alert effects. The neural haptic effect process 1200 may be carried out by any of the neural haptic systems 100 described herein.

In an operation 1202, the neural haptic system 100 establishes a connection with an external interactive user device, e.g., a computer system or other device. Such a device or computer system may include, for example, a smartphone, tablet, personal computer, vehicle computer, AR/VR display or system, or any other interactive user device.

In an operation 1204, the neural haptic system 100 receives a haptic notification, e.g., a notification that a haptic effect should output to alert a user of a notification or other alert, from the interactive user device. The haptic notification may be generated by the interactive user device in response to an event occurring on the interactive user device, such as, for example, an incoming text, call, or other notification or any other event for which such an interactive user device might provide a haptic output.

In an operation 1206, the neural haptic system 100 generates and provides a neural haptic signal to cause a peripheral nervous system stimulus. The neural haptic signal may be generated, e.g., by the haptic effect rendering module 116, based on a haptic effect created by the haptic effect creator 114. The haptic effect creator 114 may create the haptic effect based on, e.g., contextual information, signal information, and/or intent information. The haptic notification is included within intent information. The neural haptic signal is provided to cause a peripheral nervous system stimulus which alerts or notifies a user of the even occurring on the interactive user device.

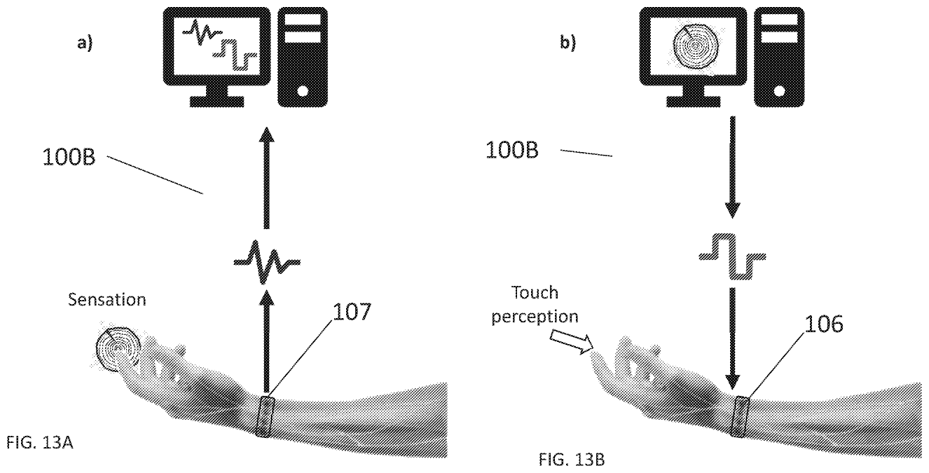

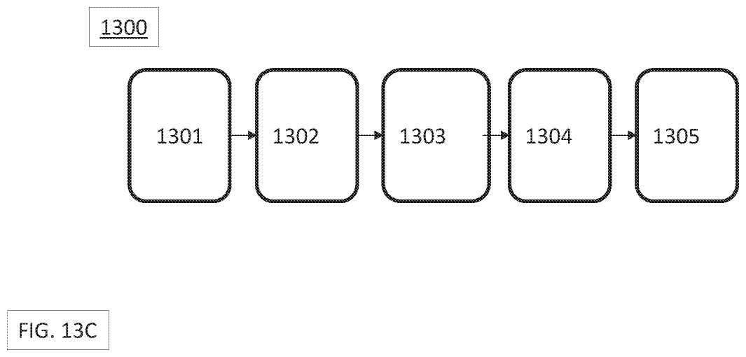

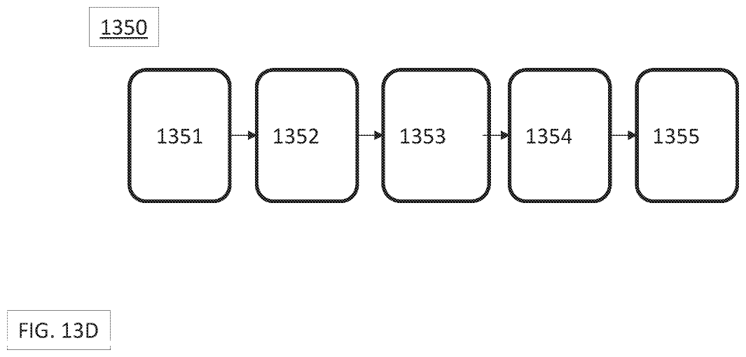

FIGS. 13A-D illustrate use of the neural haptic system 100 used to detect neural signals and provide neural haptic signals as an output. FIGS. 13A and 13B illustrates use of neural haptic system 100B (e.g., with a bracelet form factor). Although FIGS. 13A and 13B illustrate the neural haptic system 100B in two parts (e.g., bracelet and computational system), as discussed above, the neural haptic system 100B may be provided with various components collocated in one or more physical devices or parts. The illustrations of FIGS. 13A and 13B are by way of example only, and there is no requirement that the system processing be performed remotely from a wearable device. FIG. 13C illustrates steps in a process for capturing and processing neural signals and producing stimulation signals. FIG. 13D illustrates steps in a process for capturing and processing neural signals and producing stimulation signals using machine learning and artificial intelligence techniques.

In embodiments, a signal processing method 1300 may be used. The neural haptic system 100 may detect neural signals in a calibration mode, e.g., at operation 1301. As illustrated in FIG. 13A, sensors 107 in the neural haptic system 100 may detect neural signals that are generated in response to a user action, such as touching a surface. The neural signals may be filtered, e.g., at operation 1302, to reduce or remove noise and/or artifacts. The detected neural signals, e.g., in the form of neuron spikes, may be decoded (e.g., by the signal decoder 112 at operation 1303) and processed by the neural haptic system 100. The spikes may be processed and characterized by appropriate signal processing methods to determine and/or identify a spike pattern characteristic of the user action. The spike pattern may represent one or more neuron spikes and may be characterized by a list or map of spikes, interspike timing, spike amplitudes, spike frequencies, and/or any other suitable characteristic. The spike pattern may then be associated with the user action. Thus, the neural haptic system 100 may associate detected neural signals with a specific user action. The neural haptic system 100 may then create neural haptic signals, e.g., at operation 1304, based on the detected neural signals (e.g., the spike pattern) to reproduce a sensation associated with the user action. The generated neural haptic signals are created so as to cause a spike pattern similar to the detected spike pattern to reproduce the sensation. Thus, the neural haptic system 100 may be calibrated by generating/creating one or more neural haptic signals associated with various user actions to be stored in a neural haptic library. The generated neural haptic signals may be then be delivered to the user, e.g., at operation 1305, via any suitable device, including devices described herein and others.

At a later time, this neural haptic library may be accessed to provide an output of the stored neural haptic signals to recreate the sensation associated with the original user action. In embodiments, the neural haptic system 100 may enact a calibration program in which it requests that the user performs certain actions repeatedly, measure the neural signals generated in response, and thereby builds a library of neural haptic signals for later use. In further embodiments, the library of neural haptic signals may be a universal library built based on the actions and responses of several users. Such a universal library may then be used for any system user, either without additional calibration or with calibration used for fine adjustments.

In embodiments, neural haptic signals, e.g., stimulation signals, may be mapped or associated with neural signals (e.g., neuron spike patterns) through a calibration operation similar to that of method 1300. Neural haptic signals may be provided to the user in place of the user action discussed above and the resulting neural signals may be captured and decoded. The captured and decoded signals (e.g., spike patterns characteristic of the neural signals), may then be associated with the neural haptic signals used to create them. Accordingly, these associations may be used when selecting the neural haptic signals to cause specific spike patterns associated with user actions. Thus, a first spike pattern may be captured, decoded, and associated with a user action. A neural haptic signal may then be generated that is configured to cause a neural signal having a second spike pattern similar to the first spike pattern such that the user action can be simulated. Spike patterns may be considered similar if they match, e.g., when pulse widths and pulse timing and frequency are compared, within 70%, within 80%, within 90%, within 95%, and/or within 99%.

In embodiments, neural signals consistent with embodiments hereof may be provided to the peripheral nervous system by the devices described herein as pulses or series of pulses (e.g., pulse trains). In examples, pulses consistent with embodiments hereof may have pulse widths of 20 to 250 microseconds, or between 24 to 60 microseconds. Pulse trains may be delivered with frequencies between 1 and 200 Hz, and/or at approximately 20 Hz. Pulse signals may vary in magnitude (e.g., as measured by current delivered to the electrodes, e.g., at the skin) between 0 and 4 mA, between 0 and 2 mA, or between 0 and 1.5 mA. In embodiments, neural signals may vary in time according to a ramp, e.g., ramping from 0 mA to a set current over a specific period of time, e.g., 1 second, 2 seconds, 4 seconds, etc. In embodiments, pulse trains consistent with embodiments hereof may be pulse width modulated by a sinusoidal signal of lower frequency. In an example, the amplitude of a 1 Hz sine wave may be used to modulate pulse widths of a higher frequency pulse train (e.g., up to 10 Hz, up to 50 Hz, up to 100 Hz, up to 200 Hz, etc.) In embodiments, pulse trains consistent with embodiments hereof may be amplitude modulated by a sinusoidal signal of lower frequency. For example, the amplitude of a 1 Hz sine wave may be used to modulate pulse amplitudes of a higher frequency pulse train (e.g., up to 10 Hz, up to 50 Hz, up to 100 Hz, up to 200 Hz, etc.)

FIG. 13D illustrates a method 1350 that employs artificial intelligence or machine learning techniques to process neural signals and generate neural haptic signals. The neural haptic system 100 may detect neural signals captured as multi-dimensional or multi-channel time domain data in a calibration mode during a user action, e.g., at operation 1351. The neural signals may be pre-processed as necessary for future operations. In embodiments, neural signals may be detected from dozens, hundreds, thousands, and/or millions of users during a similar user action. User actions may include specific movements and/or more prolonged actions, such as exploring the characteristics (texture, shape, etc.) of an object.

At operation 1352, the neural haptic system may operate to extract specific features from the captured neural signals. Feature extraction may include extraction of statistical features, time based features, shape based features, autocorrelation features, wavelet transform features, Fourier transform features, entropy measures, higher order crossings, empirical mode decomposition, and others. Statistical features may include, for example, Mean, Standard Deviation, Variance, Median, Skewness, Kurtosis, Maximum and Minimum Values, Range, and others. Time based features may include, for example, Zero Crossing Rate (ZCR), Root Mean Square (RMS), Peak-to-Peak Distance, Signal Slope Changes, and others. Shape features may include, for example, crest factor, form factor, signal-to-noise ratio, and others. Entropy measures may include Shannon entropy and/or spectral entropy, and others.

At operation 1354, the neural haptic system 100 may operate to generate a tactile model according to the extracted features. The tactile model may be characteristic of the physical world associated with the user action performed during data capture. In embodiments, the tactile model may be generated according to one or more of the following methods: Convolutional Neural Networks (CNNs), Recurrent Neural Networks (RNNs), Autoencoders, Generative Adversarial Networks (GANs), Transformer Models, Feedforward Neural Networks (FNNs), Deep Belief Networks (DBNs), Capsule Networks, Attention Mechanisms, Variational Autoencoders (VAEs), and others.

At operation 1355, the neural haptic system 100 may operate to apply the tactile model to generate neural haptic signals to be sent to a neural haptic device, e.g., electrodes of a haptic output device, to generate sensations consistent with the user actions associated with the tactile model. Such signals may then be sent to the neural haptic device to generate the sensations.

In another example of a calibration mode, the neural haptic system 100 may be configured to identify or locate a nerve and/or identify or select a best electrode for obtaining neural stimulus. For example, referring now to FIG. 4, a neural haptic system 100B including a plurality of transcutaneous electrodes 401 is shown. During a calibration mode, the transcutaneous electrodes 401 may be activated singularly and/or in various combinations. As each electrode 401 or combination of electrodes 401 is activated, a user may input information into the neural haptic system 100 to identify which activations were effective and which were not effective. After conducting such a calibration, the neural haptic system 100 may identify the electrodes 401 that provide the most effective neural stimulation according to the user. The identified electrodes 401 may be indicative or representative of a location of the ulnar nerve 302 or median nerve 301 within the user. In embodiments, such a calibration mode may further include the use of neural haptic signals of differing intensity, differing frequency, differing pattern, etc., to further enhance the calibration. In a further embodiment, location of the nerves may be detected by ultrasound or other imaging technique. In such a case, the results of the imaging may undergo image processing to detect, determine, and/or find the location of the ulnar nerves 302 and median nerves 301.

In still another example of a calibration mode, the neural haptic system 100 may perform calibration methods in conjunction with a virtual environment and virtual reality system 1100 (as in FIG. 11). For example, in a motor neuron signal calibration operation, the neural haptic system 100 may receive and decode motor neural signals and associate such signals with a motion occurring within the virtual environment. For example, a user may move their arm to touch an object. The virtual reality system 1100 may track the user's motion according to cameras or other sensors associated with the virtual reality system 1100. At the same time, the neural haptic system 100 may receive and decode motor neural signals associated with the same movement. The neural haptic system may then associate the received motor neural signals with the captured motion, thus providing the capability of tracking user motion based on neural signals. Still further, when a user contacts the object within the virtual reality environment, the virtual reality system 1100 may provide tactile haptic stimulus associated with such contact. The neural haptic system 100 may receive and decode the sensory neural signals generated by the tactile haptic stimulus and then associate the received/decoded sensory neural signals with the haptic stimulus, thus providing the capability of providing neural haptic stimulus to replace or augment the tactile haptic stimulus provided by the virtual reality system 1100.

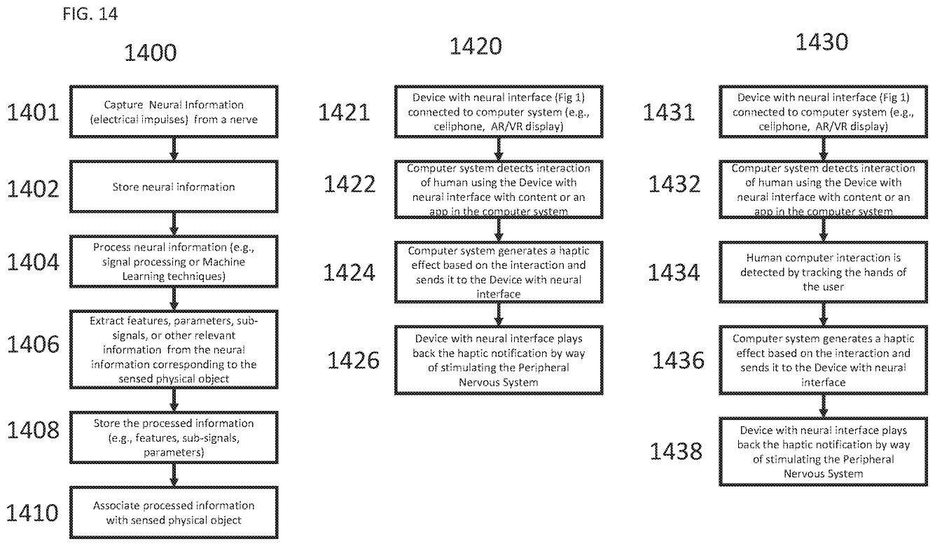

FIG. 14 illustrates flow charts illustrating steps in various methods for generating and providing neural haptic effects associated with an interactive user system. The neural haptic effect processes 1400, 1420, and 1430 may be carried out by any of the neural haptic systems 100 described herein.

The neural haptic effect process 1400 provides operational steps for generating neural haptic signals to be associated with user actions

In an operation 1401, the neural haptic effect process 1400 includes a step of capturing neural information (e.g., neural signals) from a nerve of a user, as described herein. The neural information may be captured while the user is carrying out a user action, for example, touching an object.

In an operation 1402, the neural haptic effect process 1400 includes a step of storing the neural information.

In an operation 1404, the neural haptic effect process 1400 includes a step of processing the neural information.

In an operation 1406, the neural haptic effect process 1400 includes a step of extracting features, parameters, sub-signals, and any other relevant information from the neural information that may correspond to the user action.

In an operation 1408, the neural haptic effect process 1400 includes a step of storing the processed information and extracted information.

In an operation 1410, the neural haptic effect process 1400 includes a step of associating the processed information with the user action. The information may be stored in a user-specific or a user-generic fashion. For example, a database or library of processed information and extracted features may be generated for an individual user associating neural signals with various user actions. In further embodiments, personal user databases may be combined between users to generate a larger and more powerful data set. Such a user-generic library may be employed to create a default knowledge base that may be applicable to any user. Such a user-generic library may be personalized for a particular user based on the neural haptic effect process 1400.

The neural haptic effect process 1420 provides operational steps for generating neural haptic signals to be output according to user interaction with an interactive user device.

In an operation 1421, the neural haptic effect process 1420 includes a step of connecting a neural haptic system 100 with an interactive user device, such as a smartphone, tablet, personal computer, gaming console, AR/VR device, etc. In embodiments, the neural haptic system 100 may be incorporated in the interactive user device. For example, a wearable device (such as a smartwatch) may be the interactive user device and may incorporate any or all of the neural haptic system 100 capabilities described herein.

In an operation 1422, the neural haptic effect process 1420 includes a step of detecting user interaction, both input and output, with an application, game, or other software in operation on the interactive user device.

In an operation 1424, the neural haptic effect process 1420 includes a step of generating providing information related to the user interaction, for example, in the form of haptic events or desired haptic effects requiring haptic outputs, to the neural haptic system 100 by the interactive user device.

In an operation 1426, the neural haptic effect process 1420 includes a step of outputting a neural haptic signal to provide a neural haptic effect to a user of the neural haptic system 100. The neural haptic effect may be associated with interactive events occurring within the game, application, or other software in operation on the interactive user device. The neural haptic system 100 may generate/determine the neural haptic signal according to methods discussed herein.

The neural haptic effect process 1430 provides operational steps for generating neural haptic signals to be output according to hand tracking of user interaction with an interactive user device.

In an operation 1431, the neural haptic effect process 1420 includes a step of connecting a neural haptic system 100 with an interactive user device, such as a smartphone, tablet, personal computer, gaming console, AR/VR device, etc.

In an operation 1432, the neural haptic effect process 1420 includes a step of detecting user interaction, both input and output, with an application, game, or other software in operation on the interactive user device.

In an operation 1434, the neural haptic effect process 1420 includes a step of tracking a user hand gestures to identify user interaction with the interactive user device.

In an operation 1436, the neural haptic effect process 1420 includes a step of generating providing information related to the user interaction, for example, in the form of haptic events or desired haptic effects requiring haptic outputs, to the neural haptic system 100 by the interactive user device.

In an operation 1438, the neural haptic effect process 1420 includes a step of outputting a neural haptic signal to provide a neural haptic effect to a user of the neural haptic system 100. The neural haptic effect may be associated with interactive events occurring within the game, application, or other software in operation on the interactive user device. The neural haptic system 100 may generate/determine the neural haptic signal according to methods discussed herein.

In embodiments, neural haptic systems 100 described herein may further be employed for assisting users with disabilities in addition to the above-described methods of providing neural haptic effects for notification and interaction purposes. For example, users with Parkinson's disease may benefit from receiving neural haptic notifications to replace mechanical haptic notifications. In another example, users that have lost sensation in a body part may benefit from neural haptic signals being provided to replace the unfelt sensations. In yet another example, users that have lost a body part may also benefit from neural haptic signals being provided to replace the unfelt sensations. In such embodiments, sensors in a prosthetic body part may capture environmental information that may be received by the neural haptic system 100 and have a neural haptic signal provided therefor.

It will be readily apparent to one of ordinary skill in the relevant arts that other suitable modifications and adaptations to the methods and applications described herein can be made without departing from the scope of any of the embodiments.

It is to be understood that while certain embodiments have been illustrated and described herein, the claims are not to be limited to the specific forms or arrangement of parts described and shown. In the specification, there have been disclosed illustrative embodiments and, although specific terms are employed, they are used in a generic and descriptive sense only and not for purposes of limitation. Modifications and variations of the embodiments are possible in light of the above teachings. It is therefore to be understood that the embodiments may be practiced otherwise than as specifically described.

1. A system for providing a neural haptic interface comprising:
a memory unit configured to store computer instructions;
at least one processor configured to execute the instructions to:
receive a notification from a peripheral device;
determine a neural haptic effect to be performed according to the notification;
generate a neural haptic signal corresponding to the neural haptic effect;
provide the neural haptic signal to a neural haptic device to render the neural haptic effect by stimulating a peripheral nervous system of a user.

2. The system of claim 1, wherein the notification is an event notification including at least one of an alarm, an alert, or a status update.

3. The system of claim 1, wherein the notification is an environmental notification, and the at least one processor is further configured to determine the neural haptic effect to provide the user with a sensation corresponding to the environmental notification.

4. The system of claim 1, wherein at least one of the neural haptic effect and the neural haptic signal are selected from a look-up table or library

5. The system of claim 1, wherein the notification is associated with a gaming system and the neural haptic effect is determined to provide feedback associated with an application of the gaming system.

6. The system of claim 1, wherein the notification is associated with a vehicle and the neural haptic effect is determined to provide feedback associated with operation of the vehicle.

7. The system of claim 4, wherein the neural haptic effect is rendered to provide a user with a sensation to replace an unfelt sensation associated with the environmental notification.

8. The system of claim 1, wherein the neural haptic device is a wearable device.

9. The system of claim 1, wherein the neural haptic device is a chair.

10. A method of generating neural haptic signals, comprising:
detecting, by at least one neural sensor of a neural haptic system, a neural signal during performance of a user action;
processing, by at least one processor of the neural haptic system, the neural signal to identify a first spike pattern characteristic of the neural signal;
associating, by the at least one processor of the neural haptic system, the spike pattern with the user action;
generating, by the at least one processor, a neural haptic signal configured to provide stimulation to a user to produce a neural response having a second spike pattern similar to the first spike pattern;
delivering, by at least one electrode, the neural haptic signal.

11. The method of claim 10, further comprising storing, by the at least one processor, the neural haptic signal associated with the user action in a neural haptic library.
